(19) United States
(12) Patent Application Publication
(10) Pub. No.: US 2012/0156942 A1
(43) Pub. Date: Jun. 21, 2012

(54) PLUG

(75) Inventor: Bill Yang, Taipei City (TW)

(73) Assignee: COTRON CORPORATION, Taipei City (TW)

(21) Appl. No.: 13/099,370

(22) Filed: May 3, 2011

(30) Foreign Application Priority Data
Dec. 15, 2010 (TW) 99144068

(51) Int. Cl. H01R 24/58

(52) U.S. Cl. 439/669

(57) ABSTRACT

A plug is used for connecting a first speaker. The first speaker includes a first magnet, a first vibrating element, and a first electromagnetic inductor. The first vibrating element vibrates relatively to the first magnet for sounding. The first electromagnetic inductor generates electricity induced by a magnetic field of the first magnet. The plug includes a first audio terminal, a pair of first power terminals, and a ground terminal. The first audio terminal is used for electrically connecting the first vibrating element. The pair of first power terminals is used for electrically connecting the first electromagnetic inductor, so as to output the electricity generated by the first electromagnetic inductor. The ground terminal is used for connecting the first vibrating element.

### CROSS-REFERENCE TO RELATED APPLICATION

This application claims the priority benefit of Taiwan application serial no. 99144068, filed on Dec. 15, 2010. The entirety of the above-mentioned patent application is hereby incorporated by reference herein and made a part of this specification.

### BACKGROUND OF THE INVENTION

1. Field of the Invention

The invention relates to a plug. More particularly, the invention relates to a plug that can output electricity generated by a speaker.

2. Description of Related Art

With the rapid progress in science and technology, all electronic products have been developed towards compact, handy, and miniaturized designs. People can use miniaturized electronic products (e.g., radios or walkmans) anytime and anywhere. Moreover, the personal digital products, such as common MP3 walkmans, mobile phones, personal digital assistants (PDAs), or notebook computers, have become popular little by little, and thus these products are indispensable in the daily life. In addition, the mobile phone integrated with functions of both radio and MP3 has emerged.

For each of the aforementioned electronic products, in order to allow a user to listen to the audio information provided by the electronic product without disturbing other people around, a headphone has become a necessary accessory to the electronic product. Moreover, the headphone also provides a listener with favorable audio transmission, and thereby the listener can clearly hear and understand the content of the audio information. In contrast to unclear audio transmission through the air, especially when the listener is moving (e.g., doing exercises, driving, intensely moving around or being in a noisy environment), the audio transmission of the headphone still would not be affected.

To allow an in-ear headphone for sounding, the headphone needs to obtain electricity from an audio player via the cord. Since the audio player is often portable, the electricity provided by the audio player to the headphone is limited. Hence, how to reduce the power consumption of the in-ear headphone or recycle energy from the headphone for the audio player has become a research topic in consideration of environmental protection. In addition, how to transmit the recycled energy from the headphone back to the audio player needs to be taken into account. Moreover, some audio players can play music through external speakers. Since the external speakers consume significant power, it is favorable to recycle the energy from the external speakers to the audio players for power reduction.

### SUMMARY OF THE INVENTION

The invention is directed to a plug which can be applied together with a vibrating element that vibrates to generate electricity for the purpose of power reduction.

In an embodiment of the invention, a plug for connecting a first speaker is provided. The first speaker includes a first magnet, a first vibrating element, and a first electromagnetic inductor. The first vibrating element vibrates relatively to the first magnet for sounding. The first electromagnetic inductor generates electricity induced by a magnetic field of the first magnet. The plug includes a first audio terminal, a pair of first power terminals, and a ground terminal. The first audio terminal is used for electrically connecting the first vibrating element. The pair of first power terminals is used for electrically connecting the first electromagnetic inductor, so as to output the electricity generated by the first electromagnetic inductor. The ground terminal is used for electrically connecting the first vibrating element.

According to an embodiment of the invention, the plug is further used for connecting a second speaker. The second speaker includes a second magnet, a second vibrating element, and a second electromagnetic inductor. The second vibrating element vibrates relatively to the second magnet for sounding. The second electromagnetic inductor generates electricity induced by a magnetic field of the second magnet. The plug further includes a second audio terminal and a pair of second power terminals. The second audio terminal is used for electrically connecting the second vibrating element. The pair of second power terminals is used for electrically connecting the second electromagnetic inductor, so as to output the electricity generated by the second electromagnetic inductor. The ground terminal is used for connecting the second vibrating element. In addition, the first audio terminal, the pair of first power terminals, the second audio terminal, the pair of second power terminals, and the ground terminal are arranged in a row and constitute a pillar, for instance.

According to an embodiment of the invention, the plug is further used for connecting a second speaker. The second speaker includes a second magnet and a second vibrating element. The second vibrating element vibrates relatively to the second magnet for sounding. The plug further includes a second audio terminal for electrically connecting the second vibrating element. The ground terminal is used for connecting the second vibrating element. In addition, the first audio terminal, the pair of first power terminals, the second audio terminal, and the ground terminal are arranged in a row and constitute a pillar, for instance.

According to an embodiment of the invention, the first audio terminal, the first power terminals, and the ground terminal are arranged in a row and constitute a pillar, for instance.

In an embodiment of the invention, another plug for connecting a first speaker is provided. The first speaker includes a first magnet, a first vibrating element, a first rectifier, and a first electromagnetic inductor. The first vibrating element vibrates relatively to the first magnet for sounding. The first electromagnetic inductor generates electricity induced by a magnetic field of the first magnet. The plug includes a first audio terminal, a first power terminal, and a ground terminal. The first audio terminal is used for electrically connecting the first vibrating element. The first power terminal is used for electrically connecting the first electromagnetic inductor via the first rectifier to output the electricity generated by the first electromagnetic inductor. The ground terminal is used for electrically connecting the first vibrating element. Besides, the ground terminal is used for electrically connecting the first electromagnetic inductor via the first rectifier.

According to an embodiment of the invention, the plug is further used for connecting a second speaker. The second speaker includes a second magnet, a second vibrating element, a second rectifier, and a second electromagnetic inductor. The second vibrating element vibrates relatively to the second magnet for sounding. The second electromagnetic inductor generates electricity induced by a magnetic field of the second magnet. The plug further includes a second audio terminal and a second power terminal. The second audio terminal is used for electrically connecting the second vibrating element. The second power terminal is used for electrically connecting the second electromagnetic inductor via the second rectifier to output the electricity generated by the second electromagnetic inductor. The ground terminal is used for electrically connecting the second vibrating element. Besides, the ground terminal is used for electrically connecting the second electromagnetic inductor via the second rectifier. In addition, the first audio terminal, the first power terminal, the second audio terminal, the second power terminal, and the ground terminal are arranged in a row and constitute a pillar, for instance.

According to an embodiment of the invention, the plug is further used for connecting a second speaker. The second speaker includes a second magnet and a second vibrating element. The second vibrating element vibrates relatively to the second magnet for sounding. The plug further includes a second audio terminal for electrically connecting the second vibrating element. The ground terminal is used for electrically connecting the second vibrating element. In addition, the first audio terminal, the first power terminal, the second audio terminal, and the ground terminal are arranged in a row and constitute a pillar, for instance.

According to an embodiment of the invention, the first audio terminal, the first power terminal, and the ground terminal are arranged in a row and constitute a pillar, for instance.

Based on the above, the plug described in the embodiments of the invention has power terminals electrically connected to the electromagnetic inductors of the speakers, so as to output the electricity generated by the electromagnetic inductors to devices that are connected to the plug.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 schematically shows the connection between a plug and a speaker according to an embodiment of the invention.

FIG. 2 is a schematic cross-sectional view illustrating that a speaker is connected to the plug depicted in FIG. 1.

FIG. 3 is a front view illustrating a circuit board in the speaker depicted in FIG. 2.

FIG. 4 is a schematic cross-sectional view illustrating the plug depicted in FIG. 1.

FIG. 5 to FIG. 9 are schematic views illustrating the connection between a plug and a speaker/speakers according to five embodiments of the invention, respectively.

### DESCRIPTION OF EMBODIMENTS

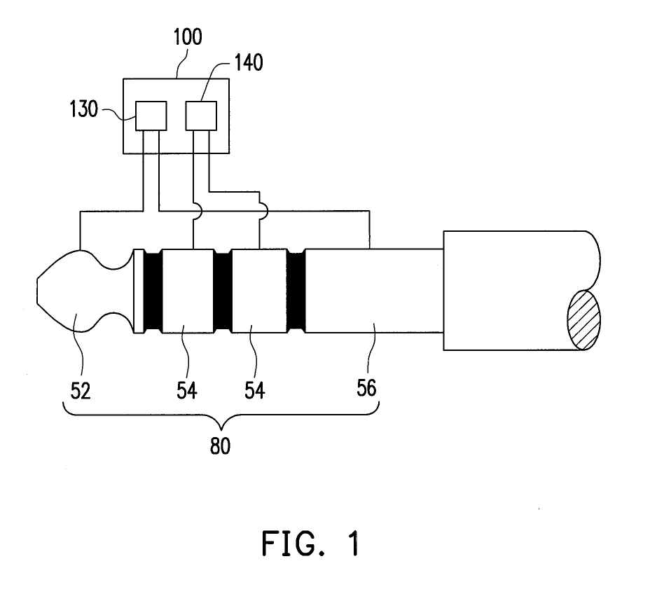

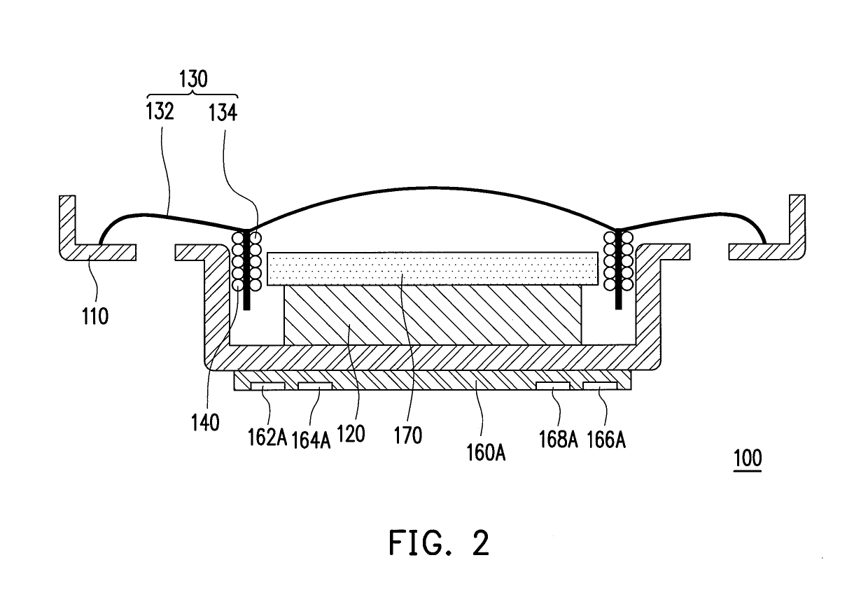

FIG. 1 schematically shows the connection between a plug and a speaker according to an embodiment of the invention. FIG. 2 is a schematic cross-sectional view illustrating that a speaker is connected to the plug depicted in FIG. 1. With reference to FIG. 1, a plug 80 of this embodiment is used for connecting a first speaker 100. The plug 80 includes a first audio terminal 52, two first power terminals 54, and a ground terminal 56. The first audio terminal 52 is used for electrically connecting a first vibrating element 130 of the first speaker 100. The two first power terminals 54 are electrically connected to a first electromagnetic inductor 140. The ground terminal 56 is used for connecting the first vibrating element 130. The plug 80 shown in FIG. 1 is similar to the actual plug in the real world, while the first speaker 100 in FIG. 1 is represented by a block.

With reference to FIG. 2, the first speaker 100 connected to the plug 80 of FIG. 1 includes a housing 110, a magnet 120, the first vibrating element 130, and the first electromagnetic inductor 140, for instance. The magnet 120 is configured in the housing 110. The first vibrating element 130 is configured in the housing 110 to vibrate relatively to the magnet 120 and deliver sound. The first electromagnetic inductor 140 is configured on the first vibrating element 130 for generating electricity induced by a magnetic field of the magnet 120. When the first speaker 100 delivers sound, the first vibrating element 130 vibrates relatively to the magnet 120 and drives the first electromagnetic inductor 140 on the first vibrating element 130 to vibrate relatively to the magnet 120. During vibration, the magnetic field of the magnet 120 induced by the first electromagnetic inductor 140 varies in terms of intensity and direction, and thereby electricity can be generated. Accordingly, even though the first speaker 100 consumes electricity in order for sounding, the first electromagnetic inductor 140 of the first speaker 100 can generate electricity.

With reference to FIG. 1 and FIG. 2, an alternating current induced by the first electromagnetic inductor 140 can be transmitted out via the two first power terminals 54 of the plug 80 to a cell phone, a portable music player, a PDA, a stereo host, or other electronic apparatuses connected to the plug 80, for instance. Hence, the plug 80 of this embodiment can output the electricity generated by the first speaker 100, and the electronic apparatus that receives the electricity can directly apply the power for operation or store the power into a battery built in the electronic apparatus. Accordingly, the plug 80 of this embodiment rather complies with the current trend of reducing energy consumption and carbon emissions. The speaker connected to the plug as described in the embodiments of the invention can be a small-size headphone or a large-size external speaker because the electricity can be generated by the electromagnetic inductor regardless of the size of the speaker.

As indicated in FIG. 2, the first vibrating element 130 includes a vibrating diaphragm 132 and a coil 134 configured on the vibrating diaphragm 132, for instance. When the magnetic field of the coil 134 varies together with variations in electrical signals input to the coil 134, the magnetic field of the coil 134 interacts with the magnetic field of the magnet 120 to move the coil 134, and thereby the vibrating diaphragm 132 is driven to vibrate and deliver sound. The coil 134 is electrically connected to the first power terminal 52 and the ground terminal 56. However, other types of the first vibrating element 130 are applicable in other embodiments of the invention. As long as the first electromagnetic inductor 140 on the first vibrating element 130 can be driven to vibrate relatively to the magnet 120, the first electromagnetic inductor 140 can generate electricity induced by the magnetic field of the magnet 120.

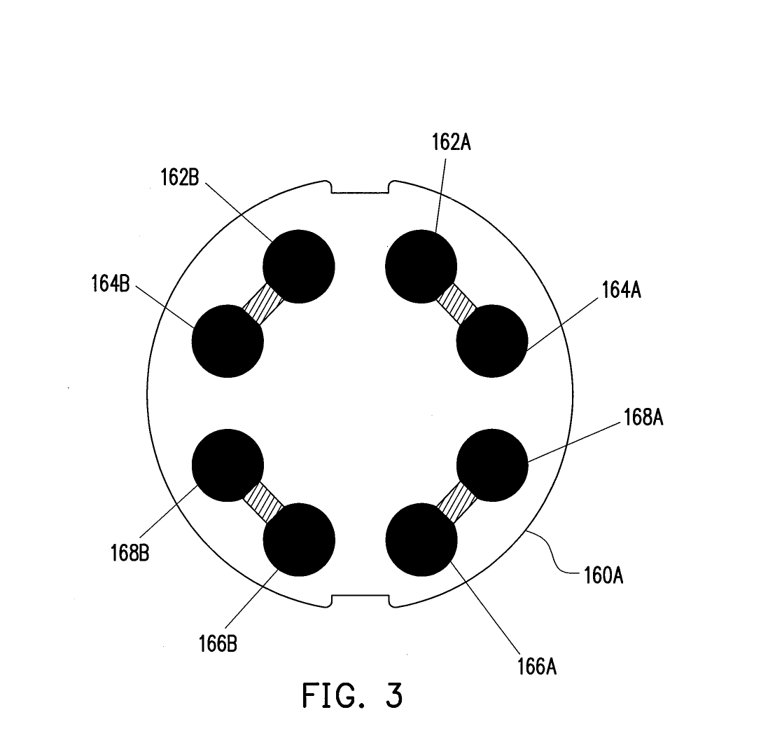

FIG. 3 is a front view illustrating a circuit board in the speaker depicted in FIG. 2. With reference to FIG. 2 and FIG. 3, the first speaker 100 further includes a circuit board 160A configured on the housing 110. The circuit board 160A has two audio output terminals 162A and 162B, two audio input terminals 164A and 164B, two power input terminals 166A and 166B, and two power output terminals 168A and 168B. In FIG. 2, some of the terminals are schematically shown. The audio input terminal 164A is electrically connected to the audio output terminal 162A. The audio input terminal 164B is electrically connected to the audio output terminal 162B. The power input terminal 166A is electrically connected to the power output terminal 168A. The power input terminal 166B is electrically connected to the power output terminal 168B. The first vibrating element 130 is electrically connected to the audio output terminals 162A and 162B. In this embodiment, the audio output terminals 162A and 162B are electrically connected to two ends of the coil 134 of the first vibrating element 130, so as to transmit audio signals to the coil 134. The first electromagnetic inductor 140 is electrically connected to the power input terminals 166A and 166B directly or indirectly, and therefore the induction current of the first electromagnetic inductor 140 can be output via the power output terminals 168A and 168B. According to this embodiment, the audio output terminals 162A and 162B, the audio input terminals 164A and 164B, the power input terminals 166A and 166B, and the power output terminals 168A and 168B are all located on the same surface of the circuit board 160A, for instance, while these terminals can also be located on different surfaces of the circuit board 160A in other embodiments of the invention. Note that the locations of each terminal as shown in FIG. 2 (the cross-sectional view of the first speaker 100) do not directly correspond to the locations of each terminal shown in FIG. 3. Particularly, the locations of each terminal are depicted in order to describe this embodiment and should not be construed as a limitation to the invention.

In this embodiment, the first electromagnetic inductor 140 is a coil, while other types of electromagnetic inductors are also applicable in other embodiments of the invention. In addition, the first speaker 100 of this embodiment can further include a yoke 170 configured on the magnet 120. The first electromagnetic inductor 140 of this embodiment generates electricity induced by the magnetic field of the magnet 120.

With reference to FIG. 1 and FIG. 3, the first audio terminal 52 of the plug 50 is electrically connected to the coil 134 of the first vibrating element 130 sequentially via the audio input terminal 164A and the audio output terminal 162A, and the coil 134 is electrically connected to the ground terminal 56 sequentially via the audio output terminal 162B and the audio input terminal 164B. One of the first power terminals 54 of the plug 50 is electrically connected to the first electromagnetic inductor 140 sequentially via the power output terminal 168A and the power input terminal 166A, and the first electromagnetic inductor 140 is electrically connected to the other first power terminal 54 of the plug 50 sequentially via the power input terminal 166B and the power output terminal 168B.

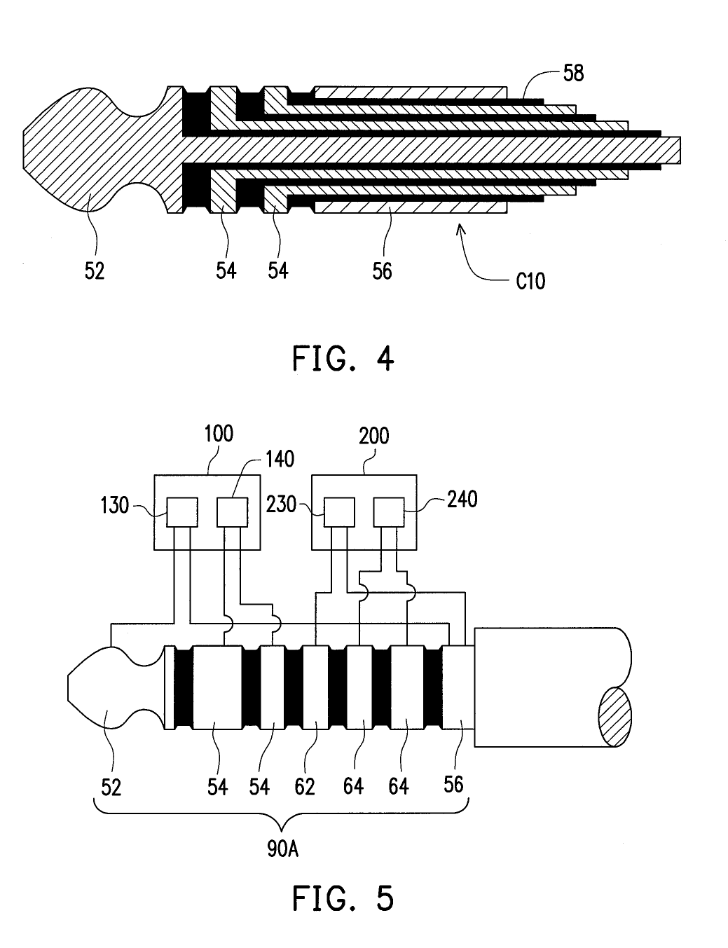

FIG. 4 is a schematic cross-sectional view illustrating the plug depicted in FIG. 1. With reference to FIG. 4, the first audio terminal 52, the two first power terminals 54, and the ground terminal 56 are arranged in a row and together constitute a pillar C10 in this embodiment. For instance, the first audio terminal 52, the two first power terminals 54, and the ground terminal 56 all have a shape of a pipe. Outer diameters of front portions of the first audio terminal 52, the two first power terminals 54, and the ground terminal 56 are substantially the same, while outer diameters of rear portions of the first audio terminal 52, the two first power terminals 54, and the ground terminal 56 are sequentially increased, such that each terminal can be configured in another terminal one by one. In addition, concentric ring-shaped gaps exist between each of the first audio terminal 52, the two first power terminals 54, and the ground terminal 56, such that the concentric ring-shaped gaps can be filled with an insulation material 58. The insulation material 58 can serve to simultaneously fix the locations of the first audio terminal 52, the two first power terminals 54, and the ground terminal 56. The order of arranging the first audio terminal 52, the two first power terminals 54, and the ground terminal 56 is not limited herein and can be adjusted based on actual requirements.

FIG. 5 schematically shows the connection between a plug and two speakers according to another embodiment of the invention. With reference to FIG. 5, the plug 90A of this embodiment is similar to the plug 80 depicted in FIG. 1, while the difference therebetween lies in that the plug 90A of this embodiment is connected to two speakers (i.e., the first and second speakers 100 and 200), and that the plug 80 depicted in FIG. 1 is connected to one speaker (i.e., the first speaker 100). The first speaker 100 and the second speaker 200 are basically the same. The second speaker 200 also has a second magnet (not shown), a second vibrating element 230, and a second electromagnetic inductor 240. The second vibrating element 230 and the second electromagnetic inductor 240 have the same functions as those of the first vibrating element 130 and the first electromagnetic inductor 140. In comparison with the plug 80 depicted in FIG. 1, the plug 90A of this embodiment additionally has a second audio terminal 62 and two second power terminals 64. The second audio terminal 62 is used for electrically connecting the second vibrating element 230. The pair of second power terminals 64 is used for electrically connecting the second electromagnetic inductor 240, so as to output the electricity generated by the second electromagnetic inductor 240. The ground terminal 56 is used for electrically connecting the first vibrating element 130 and the second vibrating element 230. The plug 90A of this embodiment can output the electricity generated by the first and second speakers 100 and 200. In addition, the first audio terminal 52, the two first power terminals 54, the second audio terminal 62, the two second power terminals 64, and the ground terminal 56 are arranged in a row and together constitute a pillar, for instance, while the shape and the arrangement order of these terminals are not limited in the invention. The terminals of each plug in the following embodiments can all be arranged in a row and together constitute a pillar, while the shape and the arrangement order of these terminals are not limited in the invention.

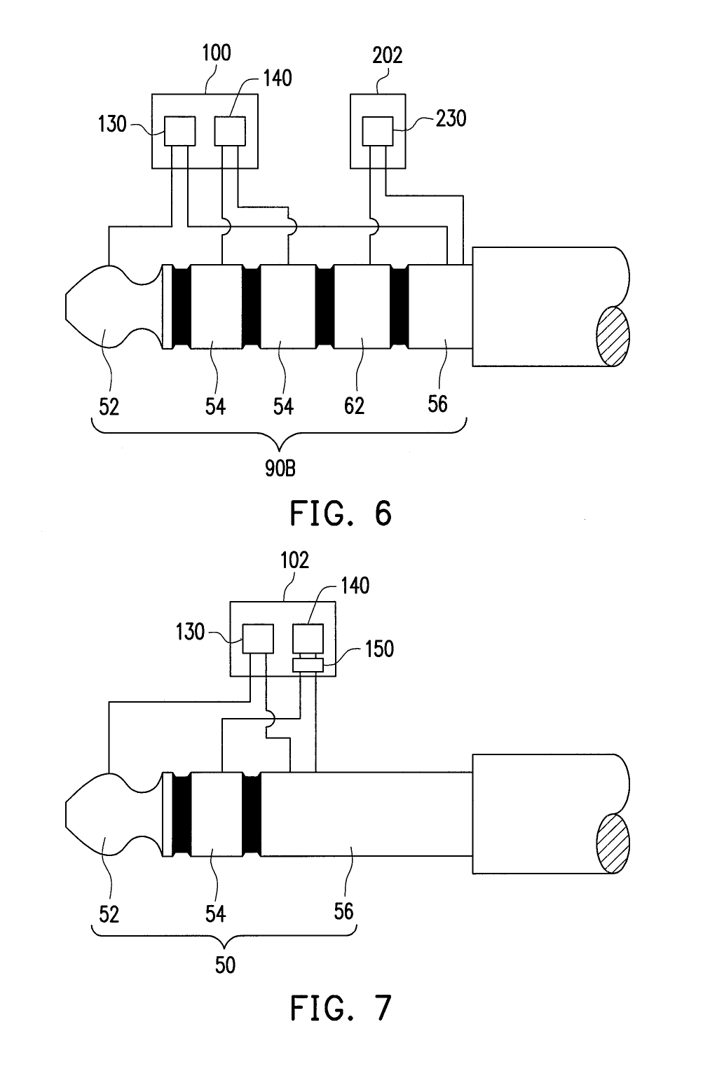

FIG. 6 schematically shows the connection between a plug and two speakers according to another embodiment of the invention. With reference to FIG. 6, the plug 90B of this embodiment is similar to the plug 90A depicted in FIG. 5, while the difference therebetween lies in that the second speaker 202 connected to the plug 90B of this embodiment does not have any electromagnetic inductor. Besides, the two second power terminals 64 of the plug 90A as shown in FIG. 5 are omitted in the plug 90B of this embodiment. The plug 90B of this embodiment can output the electricity generated by the first speaker 100.

FIG. 7 schematically shows the connection between a plug and a speaker according to another embodiment of the invention. With reference to FIG. 7, the plug 50 of this embodiment is similar to the plug 80 shown in FIG. 1, while the difference therebetween lies in that the plug 50 of this embodiment has one first power terminal 54. The first power terminal 54 is electrically connected to the first electromagnetic inductor 140, while the ground terminal 56 is electrically connected to the first vibrating element 130 and the first electromagnetic inductor 140. Namely, the first vibrating element 130 and the first electromagnetic inductor 140 share the same ground terminal 56. In compliance with said design, the first speaker 102 is required to have a rectifier 150. The rectifier 150 is used for converting the alternating electricity induced by the first electromagnetic inductor 140 into direct electricity and transmitting the direct electricity to the first power terminal 54. The types of the rectifier 150 and the detailed connection of each element are well known to people having ordinary skill in the art and are thus not reiterated herein.

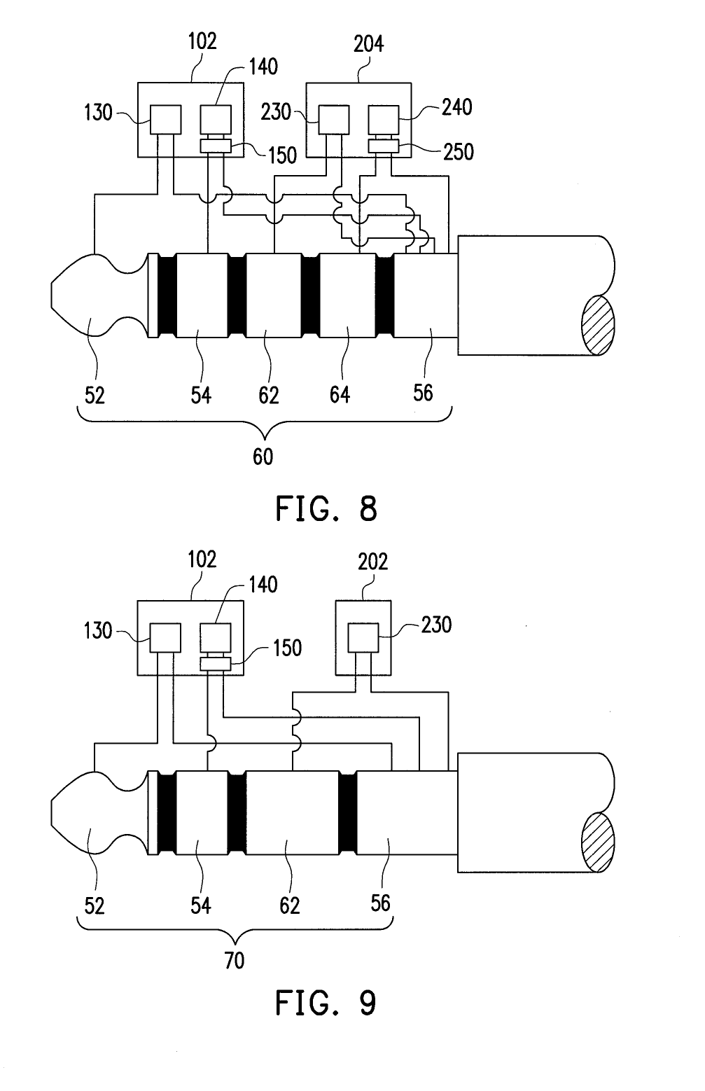

FIG. 8 schematically shows the connection between a plug and two speakers according to another embodiment of the invention. With reference to FIG. 8, the plug 60 of this embodiment is similar to the plug 50 depicted in FIG. 7, while the difference therebetween lies in that the plug 60 of this embodiment is connected to two speakers (i.e., the first and second speakers 102 and 204), and that the plug 50 depicted in FIG. 7 is connected to one speaker (i.e., the first speaker 102). The first speaker 102 and the second speaker 204 are basically the same. The second speaker 204 also has a second magnet (not shown), a second vibrating element 230, a second electromagnetic inductor 240, and a rectifier 250. The second vibrating element 230 and the second electromagnetic inductor 240 have the same functions as those of the first vibrating element 130 and the first electromagnetic inductor 140. In comparison with the plug 50 depicted in FIG. 7, the plug 60 additionally has a second audio terminal 62 and a second power terminal 64. The second audio terminal 62 is used for electrically connecting the second vibrating element 230. The second power terminal 64 is used for electrically connecting the second electromagnetic inductor 240, so as to output the electricity generated by the second electromagnetic inductor 240. The ground terminal 56 is used for electrically connecting the first vibrating element 130, the first electromagnetic inductor 140, the second vibrating element 230, and the second electromagnetic inductor 240. The plug 60 of this embodiment can output the electricity generated by the first and second speakers 102 and 204. In addition, the first audio terminal 52, the first power terminal 54, the second audio terminal 62, the second power terminal 64, and the ground terminal 56 are arranged in a row and together constitute a pillar, for instance, while the shape and the arrangement order of these terminals are not limited in the invention. The terminals of each plug in the following embodiments can all be arranged in a row and together constitute a pillar, while the shape and the arrangement order of these terminals are not limited in the invention.

FIG. 9 schematically shows the connection between a plug and two speakers according to another embodiment of the invention. With reference to FIG. 9, the plug 70 of this embodiment is similar to the plug 60 depicted in FIG. 8, while the difference therebetween lies in that the second speaker 202 connected to the plug 70 of this embodiment does not have any electromagnetic inductor. Besides, the second power terminal 64 of the plug 60 as shown in FIG. 8 is omitted in the plug 70 of this embodiment. The plug 70 of this embodiment can output the electricity generated by the first speaker 102.

In light of the foregoing, the plug described in the embodiments of the invention has the power terminal electrically connected to the electromagnetic inductor of the speaker, so as to output electricity generated by the electromagnetic inductor to a cell phone, a portable music player, a PDA, a stereo host, or other electronic apparatuses connected to the plug, for instance. Since the plug described in the embodiments can output the electricity, the electronic apparatus that is connected to the plug and receives the electricity can directly apply the power for operation or store the power into a battery built in the electronic apparatus. Accordingly, the plug of this invention rather complies with the current trend of reducing energy consumption and carbon emissions.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A plug for connecting a first speaker, the first speaker comprising a first magnet, a first vibrating element, and a first electromagnetic inductor, the first vibrating element vibrating relatively to the first magnet for sounding, the first electromagnetic inductor generating electricity induced by a magnetic field of the first magnet, the plug comprising:
a first audio terminal for electrically connecting the first vibrating element;
a pair of first power terminals for electrically connecting the first electromagnetic inductor to output the electricity generated by the first electromagnetic inductor; and
a ground terminal for connecting the first vibrating element.

2. The plug as recited in claim 1, the plug being suitable for further connecting a second speaker, the second speaker comprising a second magnet, a second vibrating element, and a second electromagnetic inductor, the second vibrating element vibrating relatively to the second magnet for sounding, the second electromagnetic inductor generating electricity induced by a magnetic field of the second magnet, the plug further comprising:
a second audio terminal for electrically connecting the second vibrating element; and
a pair of second power terminals for electrically connecting the second electromagnetic inductor to output the electricity generated by the second electromagnetic inductor, the ground terminal being suitable for electrically connecting the second vibrating element.

3. The plug as recited in claim 2, wherein the first audio terminal, the pair of first power terminals, the second audio terminal, the pair of second power terminals, and the ground terminal are arranged in a row and constitute a pillar.

4. The plug as recited in claim 1, the plug being suitable for further connecting a second speaker, the second speaker comprising a second magnet and a second vibrating element, the second vibrating element vibrating relatively to the second magnet for sounding, the plug further comprising:
a second audio terminal for electrically connecting the second vibrating element, the ground terminal being suitable for electrically connecting the second vibrating element.

5. The plug as recited in claim 4, wherein the first audio terminal, the pair of first power terminals, the second audio terminal, and the ground terminal are arranged in a row and constitute a pillar.

6. The plug as recited in claim 1, wherein the first audio terminal, the pair of first power terminals, and the ground terminal are arranged in a row and constitute a pillar.

7. A plug for connecting a first speaker, the first speaker comprising a first magnet, a first vibrating element, a first rectifier, and a first electromagnetic inductor, the first vibrating element vibrating relatively to the first magnet for sounding, the first electromagnetic inductor generating electricity induced by a magnetic field of the first magnet, the plug comprising:
a first audio terminal for electrically connecting the first vibrating element;
a first power terminal for electrically connecting the first electromagnetic inductor via the first rectifier to output the electricity generated by the first electromagnetic inductor; and
a ground terminal for electrically connecting the first vibrating element and electrically connecting the first electromagnetic inductor via the first rectifier.

8. The plug as recited in claim 7, the plug being suitable for further connecting a second speaker, the second speaker comprising a second magnet, a second vibrating element, a second rectifier, and a second electromagnetic inductor, the second vibrating element vibrating relatively to the second magnet for sounding, the second electromagnetic inductor generating electricity induced by a magnetic field of the second magnet, the plug further comprising:
a second audio terminal for electrically connecting the second vibrating element; and
a second power terminal for electrically connecting the second electromagnetic inductor via the second rectifier to output the electricity generated by the second electromagnetic inductor, the ground terminal being suitable for electrically connecting the second vibrating element and electrically connecting the second electromagnetic inductor via the second rectifier.

9. The plug as recited in claim 8, wherein the first audio terminal, the first power terminal, the second audio terminal, the second power terminal, and the ground terminal are arranged in a row and constitute a pillar.

10. The plug as recited in claim 7, the plug being suitable for further connecting a second speaker, the second speaker comprising a second magnet and a second vibrating element, the second vibrating element vibrating relatively to the second magnet for sounding, the plug further comprising:
a second audio terminal for electrically connecting the second vibrating element, the ground terminal being suitable for electrically connecting the second vibrating element.

11. The plug as recited in claim 10, wherein the first audio terminal, the first power terminal, the second audio terminal, and the ground terminal are arranged in a row and constitute a pillar.

12. The plug as recited in claim 7, wherein the first audio terminal, the first power terminal, and the ground terminal are arranged in a row and constitute a pillar.
